(19) United States
(12) Patent Application Publication
(10) Pub. No.: US 2025/0319555 A1
(43) Pub. Date: Oct. 16, 2025

(54) Friction taper clamping system for a machine tool, machine tool, and method for machining a workpiece with a machine tool

(71) Applicant: Adelbert Haas GmbH, Trossingen (DE)

(72) Inventors: Timo ZEPF, Seitingen-Oberflacht (DE); Dirk WEMBER, Rottweil (DE)

(21) Appl. No.: 19/170,809

(22) Filed: Apr. 4, 2025

(30) Foreign Application Priority Data
Apr. 11, 2024 (DE) 102024110155.5

(51) Int. Cl. B23Q 1/44

(52) U.S. Cl. CPC B23Q 1/44

(57) ABSTRACT

A friction taper clamping system includes a rotationally symmetrical base body, on which a friction taper attachment with a workpiece holder forming a friction taper is arranged, and a centering element with a centering tip. The centering element is displaceably arranged parallel to the axis of symmetry of the rotationally symmetrical base body in an opening that traverses the base body as well as the friction taper attachment, which opening transitions into the workpiece holder. The centering element can be moved between an extended position, in which the centering tip protrudes from the workpiece holder, and a retracted position, in which the centering tip is located within the workpiece holder. The base body includes at least one clamping device which is configured and set up, at least in the extended position, to clamp the centering element, so that a rotation of the base body is transmitted to the centering element.

The invention relates to a friction taper clamping system for a machine tool, a machine tool, and a method for machining a workpiece with a machine tool.

Friction taper clamping systems are a long-established type of workpiece holder for machine tools. They are characterized in that the holder for the workpiece to be machined tapers conically, in particular in a taper-shape, from its end face, facing the workpiece, in the direction of the machine spindle. The workpiece is pressed into the holder—usually by means of a tailstock of the machine tool—and is preferably centered by the geometry of the holder. The frictional engagement created during the pressing-in process leads, in particular, to the rotation of the machine spindle being transferred to the workpiece.

Typical advantages of friction taper clamping systems are that they are less expensive than compensating chucks actuated hydraulically, pneumatically or by means of tie/push rod, that they exhibit significantly higher transmission and compensating torques than hydraulic compensating chucks with the same diameter, and that they have a maximum rigidity, since the friction taper is firmly connected to the spindle of the rotational axis, whereas with a compensating chuck, the guide play in the movable clamping jaws and the movable chuck body results in backlash and a soft or flexible clamping in the direction of rotation.

The frictional engagement between the friction taper and the workpiece that occurs during the pushing-in can be so strong that the workpiece does not detach itself from the friction taper clamping system on its own, even if the pressurization, which can be applied, in particular, by the tailstock, is removed. It is therefore known to provide the friction taper clamping system with an axially displaceable ejector, which ejector can be designed in particular as a mandrel.

In order to exploit the full potential of a friction taper clamping system in terms of the precision that can be achieved when machining the workpiece, it is, however, necessary in a large number of applications to cylindrically grind the workpiece before inserting it into the friction taper of the friction taper clamping system, for which purpose it must be inserted into a different tool holder. In such applications, this leads, until now, to the absolute need for reclamping.

The task of the invention, therefore, consists in providing a friction taper clamping system, a machine tool and a method for machining a workpiece, with which cylindrical grinding can also be performed before the workpiece is received in the friction taper without reclamping the workpiece. This task is solved by a friction taper clamping system with the features of patent claim 1, a machine tool with the features of patent claim 13, and a method for machining a workpiece with the features of patent claim 16. Advantageous further developments of the invention are the subject of the respective dependent patent claims.

The friction taper clamping system according to the invention comprises a rotationally symmetrical base body on which a—preferably but not necessarily interchangeable—friction taper attachment is arranged with a workpiece holder forming the friction taper and a centering element with a centering tip. The centering element is displaceably arranged in an opening that traverses the base body as well as the friction taper attachment concentrically with the axis of symmetry, parallel to the axis of symmetry of the rotationally symmetrical base body, around which axis the centering element rotates during its use in a machine tool, which opening transitions into the workpiece holder forming the friction taper. Accordingly, the centering element can be moved along this axis of symmetry, which typically also represents the central axis of the centering element, between an extended position, in which the centering tip protrudes from the workpiece holder, and a retracted position, in which the centering tip is located within the workpiece holder.

It is essential to the invention that the base body comprises a clamping device which is configured and set up, at least in the extended position, to clamp the centering element centrally, which is to say, with forces acting on the centering element in the radial direction, so that a rotation of the base body is transmitted to the centering element.

The use of this measure makes it possible for the workpiece to initially be held only between the extended centering tip and a second tip, typically the tip of a tailstock of the machine tool, for an upstream cylindrical grinding process, and for the workpiece to be driven by the clamped centering tip. After this cylindrical grinding process, in which the clamping diameter for clamping can be generated in the friction taper itself, the workpiece can then be pressed into the friction taper with the tailstock, while the centering tip is retracted or pushed back. Of course, this only takes place after the tension on the centering tip has been released to allow it to move.

In order to enable high precision during machining, it is advantageous if the opening in the friction taper attachment comprises at least one section with a reduced diameter into which is inserted the centering tip, which is preferably formed by an end section of the centering element with a smaller diameter, the free end of which is shaped into a tip.

The above-mentioned cylindrical grinding processes can be performed with particular precision if the centering tip is guided in at least two planes. An alternative or additional possibility to achieve high precision is to provide the workpiece with a reference geometry in which the centering tip is pressed in.

It has, in particular, proven to be advantageous for achieving maximum precision if the centering element is guided in a section of the opening within the base body and—typically with the section of the centering element that forms the centering tip—in a section of the opening within the friction taper attachment.

By providing at least one outlet opening for feeding sealing air or coolant into the opening, the opening can be kept free and the ingress of dirt and chips produced during machining of the workpiece can be prevented.

A particularly preferred embodiment of the clamping device is its configuration as a hydraulic chuck. This is preferably operated pneumatically.

Preferably, means, for example, optical or magnetic sensors or probes, are provided for monitoring at least whether the axial end position of the centering tip in the extended state has been reached. As an alternative to a position query on the movable tip, the clamping stroke of the pneumatic clamping cylinder or alternatively the tie/push rod can also be queried by means of a position measuring system, which has the advantage that no sensors need to be installed in the clamping device itself.

It is, in particular, advantageous if the clamping device is clamped when the centering tip reaches its maximum extended position. A particularly simple way to achieve this for a clamping device configured as a hydraulic expansion diaphragm is to have a piston actuate when the centering tip reaches its maximum extended position, which then initiates the pressing of a fluid into a preferably annular chamber in the base body that is closed by the hydraulic expansion diaphragm. In this embodiment, the piston or position monitoring of the position of the tie/push rod therefore forms the means of monitoring.

The position of the workpiece can likewise be determined using the measuring probe of the machine. The verification as to whether the workpiece is fully seated and pressed into the friction taper can also be performed by means of the sealing air or coolant flushing using air sensors or fluid sensors. If the workpiece is in contact with the friction taper, no more air or coolant can escape.

In a particularly preferred embodiment of the friction taper clamping system, a support spring is arranged on the centering element at its end opposite the centering tip. This can fulfill several functions: Firstly, it ensures that the centering tip rests against the workpiece pressed into the friction taper with a low spring force during machining in the friction taper, thereby avoiding a negative influence on concentricity. Secondly, it can be used for leading or lagging control of the clamping mechanism. The part to be machined is, moreover, held between the tips as an insertion aid so that it can be pressed into the friction taper while being held coaxially on centering bores.

Preferably, the friction taper attachment is replaceably arranged on the base body so that it can be easily replaced upon wear of the friction taper. If this is done by holding and/or clamping the friction taper attachment in a zero-point clamping system, the friction taper attachment can be replaced automatically.

Alternatively, the friction taper attachment can be positioned on the base body with high repeat accuracy by means of a precision interface by centering the friction taper attachment by means of a cone and/or by orienting it rotationally by means of indexing.

It may also be expedient to mount the centering element in the opening so that it is secured against rotation in order to ensure that the rotation of the base body is transmitted even when high forces are applied.

The machine tool according to the invention comprises a friction taper clamping system according to the invention, a tailstock and a spindle with an axially displaceable tie/push rod, so that the fixing element is displaceable in the opening traversing the base body and the friction taper attachment, which opening transitions into the workpiece holder, by actuation of the tie/push rod.

A machine tool, the tailstock of which comprises a live centering tip, is particularly well-suited for carrying out the cylindrical grinding with the workpiece mounted on the extended centering tip and set in rotation by it.

It is, moreover, preferable if a spring is arranged on the machine tool on the side of the centering element opposite the centering tip, which spring is supported on the tie/push rod and if the clamping mechanism is controlled in a leading or trailing manner based on the compression of the spring.

In the method according to the invention for machining a workpiece with a machine tool according to the invention, a cylindrical grinding machining step is initially performed and subsequently a profile grinding machining step is performed on a workpiece. The method is characterized in that the cylindrical grinding machining step is performed while the workpiece is held between the extended and radially clamped centering tip and the tip of the tailstock, in that the workpiece is subsequently pressed into the friction taper upon reduction of the distance between the friction taper clamping system and the tip of the tailstock, wherein the radially relaxed centering tip is pushed back, and in that the profile grinding machining step is subsequently performed.

For a further automation of the process, the machined workpiece can be ejected with the centering tip after completion of the profile grinding step.

It is particularly preferable if a seating contact surface in the friction taper is machined out of the workpiece during the cylindrical grinding step.

The invention is elucidated in more detail below on the basis of figures showing one embodiment example. Wherein:

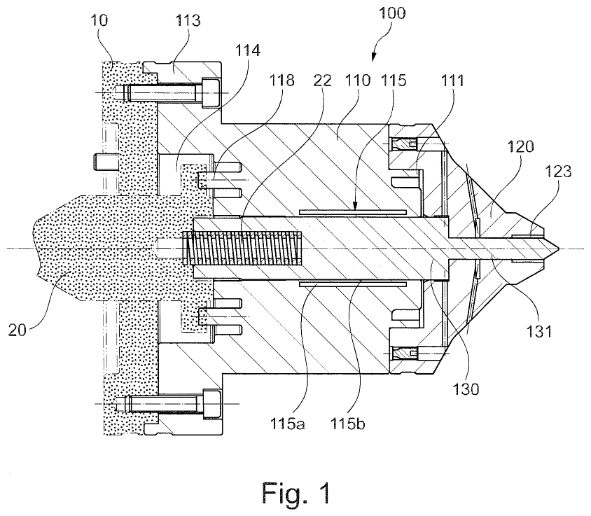

FIG. 1 shows a cross-section through a first friction taper clamping system with extended centering tip,

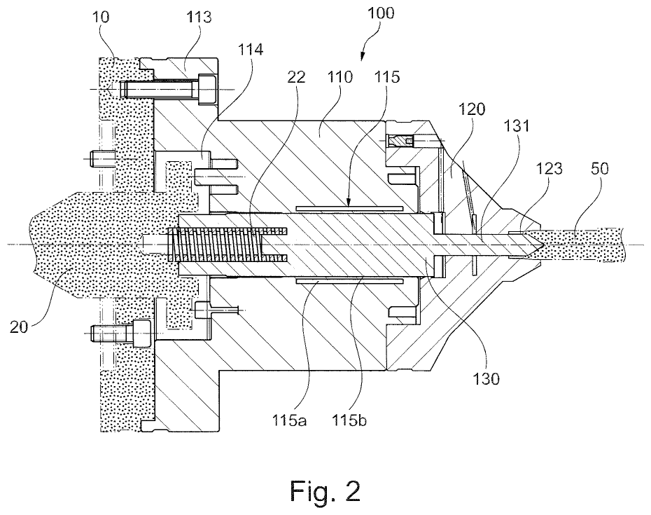

FIG. 2 shows a cross-section through the first friction taper clamping system from FIG. 1 with retracted centering tip,

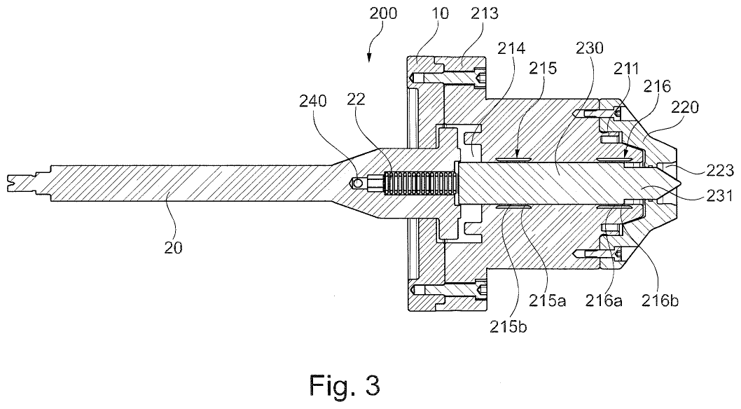

FIG. 3 shows a cross-section through a second friction taper clamping system

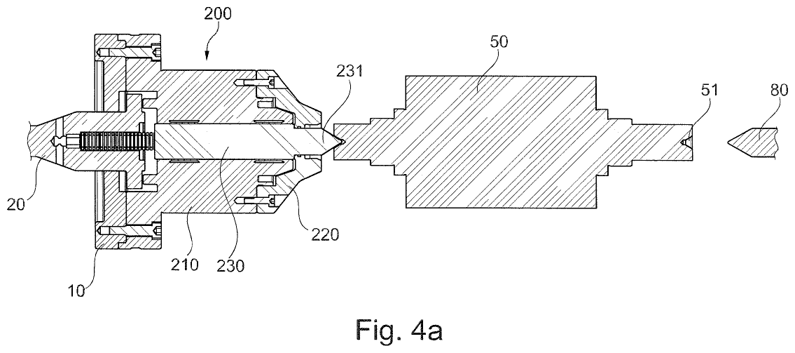

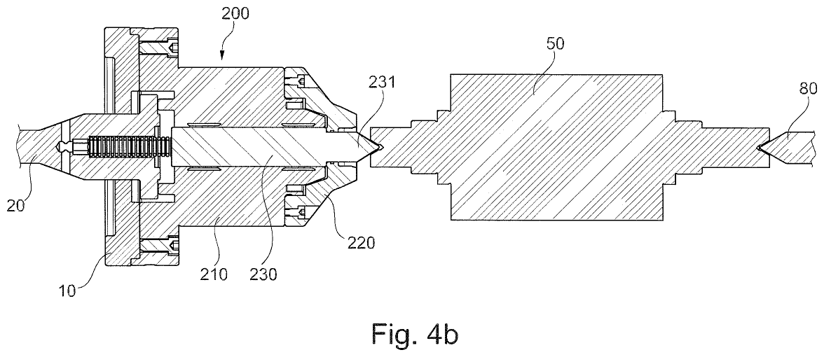

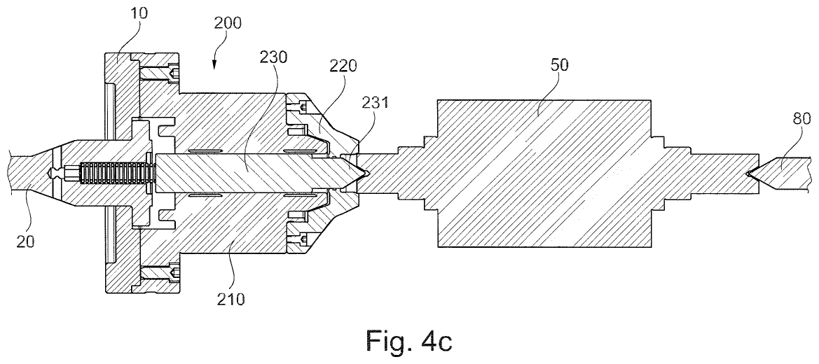

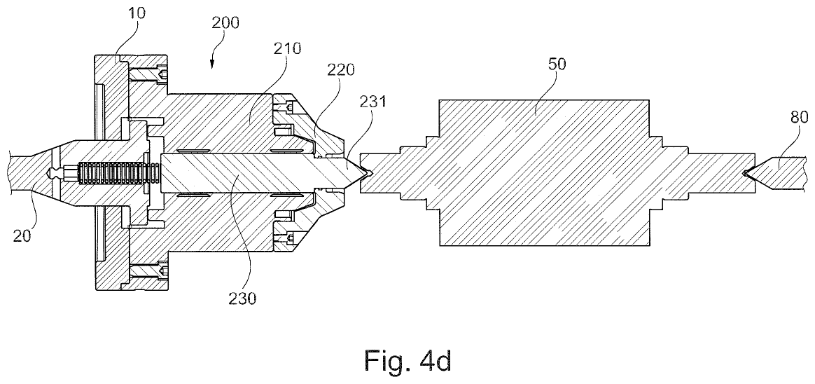

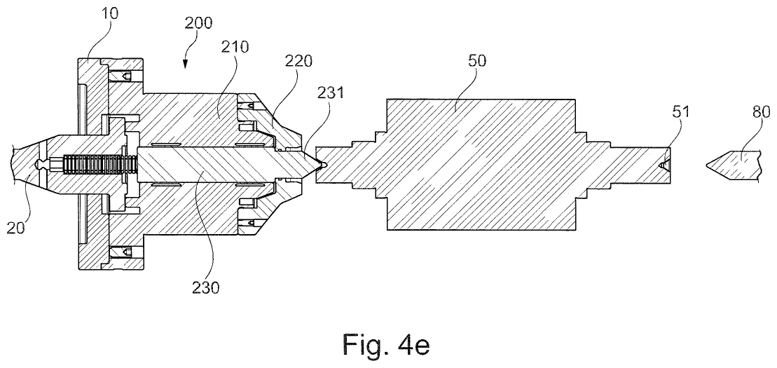

FIG. 4a shows a first stage in the execution of a method according to the invention,

FIG. 4b shows a second stage in the execution of the method from FIG. 4a,

FIG. 4c shows a third stage in the execution of the method from FIG. 4a

FIG. 4d shows a fourth stage in the execution of the method from FIG. 4a, and

FIG. 4e shows a fifth stage in the execution of the method from FIG. 4a.

The same reference signs are used for the same friction taper clamping systems in all figures that show them. However, to improve the clarity of the figures, not all reference signs are shown in all figures.

FIG. 1 shows a first friction taper clamping system 100 with a rotationally symmetrical base body 110, on which a friction taper attachment 120 is arranged on one of the end faces of the base body 110 in a rotationally fixed manner. In the example shown here, this is done by screw connection using screws. A repeat accuracy in positioning is achieved by centering the friction taper attachment 120 by means of a projection of the base body 110 configured as a cone 111, which engages in a holder in the friction taper attachment 120, and orienting it rotationally by means of an indexing not shown, which engages in the friction taper attachment.

In the end region of the base body 110 opposite the friction taper attachment 120, there is a flange 113 by means of which the base body 110 is connected in a non-rotatable manner to a spindle 10 of a machine tool in such a way that the axis of rotation of the spindle 10 and the axis of symmetry of the rotationally symmetrical base body 110 coincide.

The spindle 10 is centrally passed through by a tie/push rod 20, which engages in a recess 114 arranged in the side of the base body 110 facing the spindle 10 and is axially displaceable within this recess 114, wherein FIG. 1 shows the tie/push rod 20 in its maximum extended position. The movement of the tie/push rod 20 can, for example, be initiated by compressed air.

On the end face of the tie/push rod 20 facing the base body 110, a centering element 130 is supported by means of a spring 22 attached to the tie/push rod 20, which traverses the base body 110 in a central opening extending in a direction parallel to its axis of symmetry. The centering element 130 extends further into an opening in the friction taper attachment 120, which likewise extends parallel to its axis of symmetry, which traverses the friction taper attachment and transitions into the workpiece holder 123 of the friction taper attachment 120, the side surfaces of which widen in the end region and form the actual friction taper.

In the region of the friction taper attachment 120, the centering element 130 transitions into a centering tip 131 formed by a section with a smaller diameter, the free end of which is pointed, and a section of the opening in the friction taper attachment has a reduced diameter adapted to the diameter of the centering tip 131 and is configured as a precision guide, so that the centering tip 131 is guided precisely when an axial movement of the centering element 130 takes place. The centering element 130 is, moreover, also guided in the area of the end of the opening in the base body 110 facing the tie/push rod 20.

In the state shown in FIG. 1, the centering element 130 is clamped to the base body 110 by a clamping device 115, so that it rotates with the base body 110 when the latter is set in rotation by the spindle 10 and this rotation is transmitted to a workpiece mounted between the centering tip 131 and a tip of a tailstock. In this embodiment example, the clamping device 115 is configured as a hydraulic expansion chuck-however in principle, it is also possible to use other clamping technology, such as a collet chuck-in which an annular recess 115a is sealed with a hydraulic expansion diaphragm 115b towards the opening in which the centering element 130 is arranged, so that by pressurization of a fluid located in the annular recess 115a, a radial force is generated in the radial direction towards the axis of symmetry or axis of rotation, which firmly clamps the centering element 130. This pressurization can be brought about, for example, by the tie/push rod 20 triggering a button or actuating a piston 118 when the centering tip 131 reaches the maximum extended end position, which rod or piston communicates with the annular recess 115a by means of a channel and compresses the fluid contained in the channel and annular recess 115b when actuated. With a suitable configuration of the spring 22, after the centering element 130 has been moved against a stop 125 within the opening in the friction taper attachment 120, the spring 22 can still protrude from the opening on the side facing the tie/push rod 20 and be compressed, whereas the tie/push rod 20 is moved further into its end position shown in FIG. 1, in which it triggers the clamping of the clamping device 115.

In order to move the centering tip 131 from the extended position shown in FIG. 1 to the retracted position shown in FIG. 2, the tie/push rod 20 is retracted. The centering element 130 is initially still clamped to the base body 110 by the clamping device 115 and therefore does not immediately follow the movement of the tie/push rod 20. However, because the connection between the tie/push rod 20 and the centering element 130 is established by means of the spring 22, the spring 22 can once again now expand or be pulled in length so that the end face of the tie/push rod 120 releases the button or piston 118. This then leads to the clamping device 115 being relaxed and the releasing of the centering element 130, which is then transferred to the retracted position shown in FIG. 2.

When the workpiece 50, as shown in FIG. 2, is inserted into the workpiece holder 123 forming the friction taper, the centering tip 131 is pressed against its end face by the force of the spring 22 so as not to influence the concentricity. The workpiece 50 is then driven by the rotation of the spindle 10 transmitted via the friction taper attachment 120, in particular its workpiece holder 123, and the base body 110.

FIG. 3 shows a second friction taper clamping system 200 with a rotationally symmetrical base body 210, to which a friction taper attachment 220 is connected in a non-rotatable manner. Here too, a high repeat accuracy positioning is achieved by centering the friction taper attachment 220 by means of a projection of the base body 210 configured as a cone 211, which engages in a holder in the friction taper attachment 220, and is rotationally oriented by means of an indexing, that is not shown.

In the friction taper clamping system 200 according to FIG. 3, the base body 210 is also connected in a non-rotatable manner to the spindle 10 of the machine tool via the flange 213, wherein the axis of rotation of the spindle 10 and the axis of symmetry of the rotationally symmetrical base body 210 coincide.

The spindle 10 is also traversed centrally by a tie/push rod 20 in FIG. 3, which engages in a recess 214 arranged in the side of the base body 210 facing the spindle 10 and is axially displaceable within this recess 214.

Here too, a centering element 230 is supported on the tie/push rod 20 by means of a spring 22 attached to the tie/push rod 20, which centering element traverses the base body 210 in a central opening extending in the direction parallel to its axis of symmetry and extends further into an opening in the friction taper attachment 220, which opening also extends parallel to its axis of symmetry, which traverses the latter and transitions into the workpiece holder 223 of the friction taper attachment 220 forming the friction taper, the side surfaces of which friction taper attachment widen in the end region and form the actual friction taper. The function of the spring 22 and its interaction with the movements of the tie/push rod 20 are analogous to the circumstances already described above in connection with the first embodiment example.

In contrast to the first embodiment example, in the part of the opening that extends in the friction taper attachment 220, there is only the centering tip 231 formed by a section with a smaller diameter, the free end of which narrows to a point, which is guided in the friction taper attachment 220.

In the embodiment example shown in FIG. 3, two clamping devices 215, 216 are provided, with which the centering element 230 is clamped in two clamping planes with the base body 210 when the centering tip 231 is extended, this so that it rotates with the base body 210 when the latter is set in rotation by the spindle 20. The clamping devices 215, 216 are again hydraulic expansion chucks with annular recesses 215a, 216a and hydraulic expansion diaphragms 215b, 216b, so that by pressurization of a fluid located in the annular recesses 215a, 216a, in the radial direction towards the axis of symmetry or alternatively towards the axis of rotation, a radial force is generated which clamps the centering element 230. In this example, this pressurization is brought about by pistons 218a, 218b, which are actuated by the tie/push rod 20 when the centering tip 231 reaches the maximum extended end position.

It is possible to also recognize an outlet opening 240 in FIG. 3 through which sealing air is blown into the opening in which the fixing element 230 is moved.

The first stage in the execution of a method according to the invention shown in FIG. 4a depicts how the workpiece 50, which is provided here with centering aids 51 on both end faces, is clamped between the extended and clamped centering tip 231 of a friction taper clamping system 200, which is shown on the left in FIG. 4a, which is constructed as shown in FIG. 3 and described above with reference to FIG. 3 and is connected to spindle 10 and tie/push rod 20 of a machine tool that is not shown, and a live tip of a tailstock 80 of the machine tool shown on the right, only in sections, in FIG. 4a.

By changing the distance between the friction taper clamping system 200 and the tailstock 80, the intermediate stage shown in FIG. 4b is brought about, in which stage the workpiece 50 is supported between the extended centering tip 231 of the friction taper clamping system 200 and the live tip of the tailstock 80, wherein a pressure is exerted by the tips which is sufficient to drive the workpiece 50 through the extended, clamped centering tip 231 and to perform a cylindrical grinding process.

After completion of this cylindrical grinding process, the centering tip 231 is relaxed and retracted, whereas the distance between the workpiece holder 223 of the friction taper clamping system 200 and the live tip of the tailstock 80 that moves in conjunction is reduced, for example, by extending it in the direction of the friction taper clamping system 200, such that the workpiece 50 is pressed with high force into the friction taper of the friction taper clamping system 200 so that a profile grinding step can be performed on the workpiece 50. At this stage, which is shown in FIG. 4c, the centering tip 231 is still only pressed against the workpiece 50 by the relatively weak force of the spring because it is no longer clamped in the base body 210. The rotation of the spindle 10 of the machine tool is transmitted to the workpiece 200 by means of the friction taper of the friction taper clamping system.

After completion of the profile grinding step, the centering tip 231 is extended and clamped again, whereas simultaneously the distance between the workpiece holder 223 and the live tip of the tailstock 80 is increased. As a result, the workpiece 50 is pushed out of the friction taper and is now once again held between the centering tip 231 and the live tip of the tailstock 80 in order to reach the fourth stage in the execution of the process which is shown in FIG. 4d.

Lastly, the live tip of the tailstock 80 that is moving in conjunction can be moved back even further, as shown in FIG. 4e, in order to remove the workpiece 50.

### LIST OF REFERENCE SIGNS

10 Spindle
20 Tie/push rod
22 Spring
50 Workpiece
51 Centering aid
80 Tailstock
100, 200 Friction taper clamping system
110, 210 Base body
111, 211 Cone
113, 213 Flange
114, 214 Recess
115, 215, 216 Clamping device
115a, 215a, 216a Recess
115b, 215b, 216b Hydraulic expansion diaphragm
118, 218a, 218b Piston
120, 220 Friction taper attachment
123, 223 Workpiece holder
130, 230 Centering element
131, 231 Centering tip
240 Outlet opening

1. Friction taper clamping system (100, 200) is provided with a rotationally symmetrical base body (110, 210) on which a friction taper attachment (120, 220) with a workpiece holder (123, 223) forming a friction taper is arranged and with a centering element (130, 230) with a centering tip (131, 231), wherein the centering element (130, 230) is displaceably arranged parallel to the axis of symmetry of the rotationally symmetrical base body (110, 210) in an opening that traverses the base body (110, 210) as well as the friction taper attachment (120, 220) concentrically to the axis of symmetry of the rotationally symmetrical base body (110, 210), which opening transitions into the workpiece holder (123, 223) forming the friction taper, so that the centering element (120, 230) can be moved between an extended position, in which the centering tip (131, 231) protrudes from the workpiece holder (123, 223), and a retracted position, in which the centering tip (131, 231) is located within the workpiece holder (123, 223)
characterized in that the base body (110, 210) comprises at least one clamping device (115, 215, 216) configured and set up, at least in the extended position, to clamp the centering element (130, 230) in a centric position, at least in the extended position, so that a rotation of the base body (110, 210) is transmitted to the centering element (130, 230).

2. Friction taper clamping system (100, 200) according to claim 1,
characterized in that the opening in the friction taper attachment (130, 230) comprises at least one section with a reduced diameter.

3. Friction taper clamping system (100, 200) according to claim 1,
characterized in that the centering tip (131, 231) is guided in at least two planes.

4. Friction taper clamping system (100, 200) according to claim 1, characterized in that the centering element (130, 230) is guided in a section of the opening within the base body (110, 210) and in a section of the opening within the friction taper attachment (120, 220).

5. Friction taper clamping system (100, 200) according to claim 1, characterized in that at least one outlet opening (240) is provided to feed sealing air or coolant into the opening.

6. Friction taper clamping system (100, 200) according to claim 1, characterized in that the clamping device (115, 215, 216) is a hydraulic chuck.

7. Friction taper clamping system (100, 200) according to claim 1, characterized in that means are provided for monitoring at least whether the axial end position of the centering tip (131, 231) in the extended state has been reached.

8. Friction taper clamping system (100, 200) according to claim 7,
characterized in that the clamping device (115, 215, 216) is set up to be clamped when the centering tip (131, 231) reaches its maximum extended position.

9. Friction taper clamping system (100, 200) according to claim 1, characterized in that a spring (22) is arranged on the centering element (130, 230) at the end opposite the centering tip (131, 231).

10. Friction taper clamping system (100, 200) according to claim 1, characterized in that the friction taper attachment (120, 220) is replaceably arranged on the base body (110, 210).

11. Friction taper clamping system (100, 200) according to claim 10,
characterized in that the friction taper attachment (120, 220) is clamped to the base body (110, 210) by a zero-point clamping system.

12. Friction taper clamping system (100, 200) according to claim 10,
characterized in that the friction taper attachment (120, 220) is positioned on the base body (110, 210) with high repeat accuracy by means of a precision interface by centering the friction taper attachment (120, 220) by means of a cone (111, 211) and/or by orienting it rotationally by means of indexing.

13. Machine tool, characterized in that the machine tool for clamping workpieces (50) comprises a friction taper clamping system (100, 200) according claim 1, and a tailstock (80), and in that the machine tool comprises a spindle (10) with an axially displaceable tie/push rod (20), so that the fixing element (130, 230) is displaceable in the opening traversing the base body (110, 210) and the friction taper attachment (120, 220), which opening transitions into the workpiece holder (123, 223) by actuation of the tie/push rod (20).

14. Machine tool according to claim 13,
characterized in that the tailstock (80) comprises a live centering tip.

15. Machine tool according to claim 13, characterized in that a spring (22) is arranged on the side of the centering element (130, 230) opposite the centering tip (131, 231), which spring is supported on the tie/push rod (22), and in that the clamping mechanism is controlled in a leading or trailing manner based on the compression of the spring (22).

16. A method of machining a workpiece (50) with a machine tool according to claim 13, in which a workpiece (50) is initially subjected to a cylindrical grinding machining step and subsequently to a profile grinding machining step,
characterized in that the cylindrical grinding machining step is performed while the workpiece (50) is held between the extended and radially clamped centering tip (131, 231) and the tip of the tailstock (80), and in that the workpiece (50) is subsequently pressed into the workpiece holder (123, 223) forming the friction taper upon reduction of the distance between the friction taper clamping system (100, 200) and the tip of the tailstock (80), wherein the radially relaxed centering tip (123,

223. is pushed back or retracted, and in that the profile grinding machining step is subsequently performed.

17. Method according to claim 16,
characterized in that the machined workpiece (50) is ejected with the centering tip (131, 231) after completion of the profile grinding machining step.

18. Method according to claim 16, characterized in that a seating contact surface in the workpiece holder (123, 223) that forms the friction taper is machined out of the workpiece (50) during the cylindrical grinding step.
